(19) United States
(12) Patent Application Publication
(10) Pub. No.: US 2009/0248810 A1
(43) Pub. Date: Oct. 1, 2009

(54) SYSTEMS AND METHODS FOR QUERYING STATUS OF PEER-TO-PEER MULTIMEDIA CONNECTIONS IN COMMUNICATION SYSTEMS

(75) Inventors: Zhongwen Zhu, Saint-Laurent (CA); Andre Godin, Laval (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/058,443

(22) Filed: Mar. 28, 2008

(51) Int. Cl. G06F 15/16

(52) U.S. Cl. 709/206

(57) ABSTRACT

Status information associated with a peer-to-peer multimedia connection can be queried by the network. A queried terminal can provide responsive status information including, for example, a type and/or amount of data which has been sent over the peer-to-peer multimedia connection and/or a type and/or amount of data which is yet to be sent over the peer-to-peer multimedia connection. This status information can, for example, be used to assist in charging or billing the customer using the multimedia service.

### TECHNICAL FIELD

The present invention relates generally to telecommunications systems and, in particular, to methods and systems for querying the status of peer-to-peer multimedia communication services and calls, e.g., for charging/billing purposes.

### BACKGROUND

Communications technologies and uses have greatly changed over the last few decades. In the fairly recent past, copper wire technologies were the primary mechanism used for transmitting voice communications over long distances. As computers were introduced, the capability to exchange data between remote sites became desirable for many purposes including those of businesses, individual users and educational institutions. The introduction of cable television and its associated coaxial cable rollout created another mechanism for increasing communications and data delivery from businesses to the public. As technology continued to move forward, digital subscriber line (DSL) transmission equipment was introduced which allowed for faster data transmissions over the existing copper phone wire infrastructure. Additionally, two way exchanges of information over the cable infrastructure became available to businesses and the public. Wireless communications have become ubiquitous with large percentages of the various populations acquiring cell phones. These numerous advances have promoted growth in service options and applications available for users.

As the consumer electronics industry continues to mature, and the capabilities of processors increase, more devices have become available for public use that allow for the transfer of data between devices and more services have become available that operate based on this transferred data. Of particular note are the Internet and local area networks (LANs). These two innovations allow multiple users and multiple devices to communicate and exchange data between different devices and device types. Regarding the Internet, its physical structure and associated communication streams have also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other Internet Protocol (IP) networks) as a mechanism for providing traditional services, as well as newer, multimedia types of services. These multimedia services include, for example, Internet Protocol television (IPTV, referring to systems or services that deliver television programs over a network using IP data packets), video on demand (VOD), voice over IP (VoIP), and other web related services received singly or bundled together. Similar comments apply to wireless networks which can also handle communications with devices through the Internet or other connected networks.

To accommodate the new and different ways in which IP networks are being used to provide various services, new network architectures are being developed and standardized. One such development is the Internet Protocol Multimedia Subsystem (IMS). IMS is an architectural framework for delivering IP multimedia services, such as IPTV or IMS messaging services, to an end user. A simplified exemplary IMS architecture is described below with respect to FIG. 1. Along with IMS architectures, Session Initiation Protocol (SIP) signaling is often used for setting up, modifying and terminating sessions between two devices. For example SIP signaling can be used between mobile devices to set up a peer-to-peer session or used between a mobile device and an application server associated with IMS for receiving a multimedia service on the mobile device. As interest in IMS grows, the quantity of IMS enabled applications being developed for end user devices, e.g., mobile phones, is increasing. This, in turn, leads to the desire to create efficient, flexible and accurate methods for charging users who access these services.

Typically, as discussed in more detail below, application servers involved in peer-to-peer multimedia services and which operate as the charging mechanisms for the provision of these services are only involved in the signaling path of the multimedia service and not in the media path, i.e., the path over which the payload information associated with the multimedia service travels. Thus, these application servers are only able to bill customers based upon the session setup information which is available to them over the signaling path, rather than the actual media content which is transferred as part of the multimedia service. The session set-up information may, or may not, provide sufficiently accurate information regarding how to charge for the multimedia call between, e.g., two mobile phones. For example, if the session is set-up between the two peer devices in order to transfer music, but later is used to transfer video, it may be desirable to bill the customer based upon the actual media transferred rather than the indication of the media to be transferred which was available at session set-up.

U.S. Patent Publication No. 2007/0174400, to Cai et al., describes a mechanism for IMS budget control for a media change during an IMS session. In this publication, IMS networks are described as allowing for media changes (e.g., audio to audio/video) during an IMS session. The mechanism described in this publication relies upon the subscriber to initiate communications associated with the media change, i.e., a push mechanism. However, network operators may prefer to exercise more control over this activity for billing purposes.

Accordingly, exemplary embodiments described below address the needs described above for status inquiry methods and systems associated with, e.g., charging for peer-to-peer multimedia services.

### SUMMARY

Systems and methods according to the present invention address this need and others by providing, for example, pull mechanisms for gathering status information which can be used to charge customers for peer-to-peer multimedia services or calls.

According to one exemplary embodiment a method for querying a status of a peer-to-peer multimedia connection includes sending a message, from an application server, querying the status of the peer-to-peer multimedia connection, and receiving a response, at the application server, regarding the status of the peer-to-peer multimedia connection.

According to another exemplary embodiment, a communication node includes a processor which sends a message which queries a status of a peer-to-peer multimedia connection, and which receives a response regarding the status of the peer-to-peer multimedia connection.

According to yet another exemplary embodiment, a method for handling a status inquiry associated with a peer-to-peer multimedia connection includes receiving a message, at a terminal device, querying the status of the peer-to-peer multimedia connection, and sending a response, from the terminal device, regarding the status of the peer-to-peer multimedia connection.

According to still another exemplary embodiment, a terminal device includes a processor which receives a message querying a status of a peer-to-peer multimedia connection and which sends a response regarding the status of said peer-to-peer multimedia connection.

### BRIEF DESCRIPTION OF THE DRAWINGS

The accompanying drawings illustrate exemplary embodiments, wherein:

FIG. 1 shows an Internet Protocol Multimedia Subsystem (IMS) architecture in which exemplary embodiments can operate;

FIG. 2(a) illustrates a peer-to-peer connection including a signaling path and a media path in which exemplary embodiments can operate;

FIG. 2(b) depicts the signaling path of FIG. 2(a) in more detail;

FIG. 3 shows a signaling diagram according to various exemplary embodiments;

FIG. 4 depicts a terminal device or communication node according to an exemplary embodiment; and

FIGS. 5(a) and 5(b) are flowcharts illustrating methods for querying a status of a peer-to-peer connection and responding thereto, respectively, according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

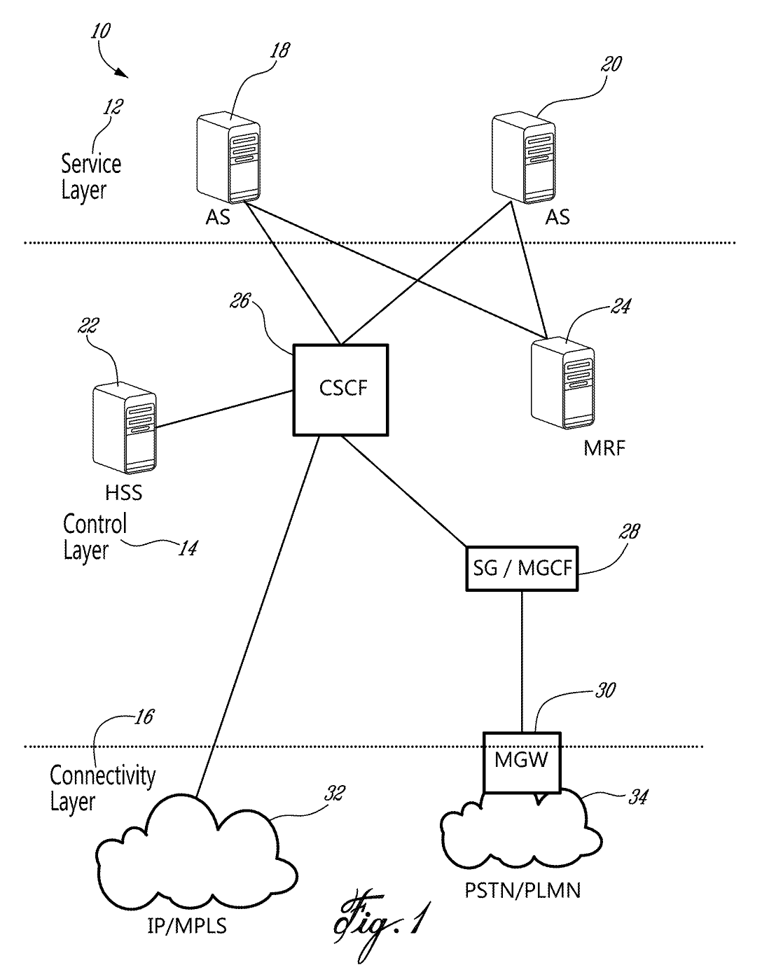

To provide some context for the following exemplary embodiments, and as mentioned briefly above, a simplified exemplary IMS system architecture 10 can, for example, be broken down into three layers: a service layer 12, a control layer 14, and a connectivity layer 16, as shown in FIG. 1. Therein, the service layer 12 includes application servers (ASs) 18, 20 which contain services and applications that can be delivered to an end user, e.g., IPTV services or IMS messaging services. The control layer 14 includes a home subscriber server (HSS) 22, a media resource function (MRF) 24, a call service control function (CSCF) 26, a signaling gateway/media gateway control function (SG/MGCF) 28 and a media gateway 30. The CSCF 26 collectively represents a number of different SIP proxies or servers which handle SIP messaging within the IMS system 10 including, for example, a serving CSCF (S-CSCF) that, among other things, determines to which of the application servers 18, 20 SIP messages are to be forwarded. These (and other) elements in the control layer 14 are typically used, for example, to manage session set-up, handle resource modification and release resources.

The connectivity layer 16 includes, for example, routers and switches used in both the backbone network and the access network. These elements are represented in FIG. 1 by Internet Protocol (IP)/multi-protocol label switching (MPLS) 32, the public switched telephone network (PSTN)/public land mobile network (PLMN) 34 and media gateway 30. The connectivity layer 16 is thus used to connect various end user devices to either each other or a variety of services and applications. Some exemplary types of end user (terminal) devices are, for example, set-top boxes (STBs), personal computers and mobile phones. It will be appreciated by those skilled in the art that more or fewer elements can exist in an IMS system or architecture. More detail regarding IMS architecture generally and SIP signaling can be found in the Third Generation Partnership Project (3GPP) Technical Specification (TS) 23.228 Version 8 dated March 2007 and Request for Comments (RFC) 3261 dated June 2002, respectively.

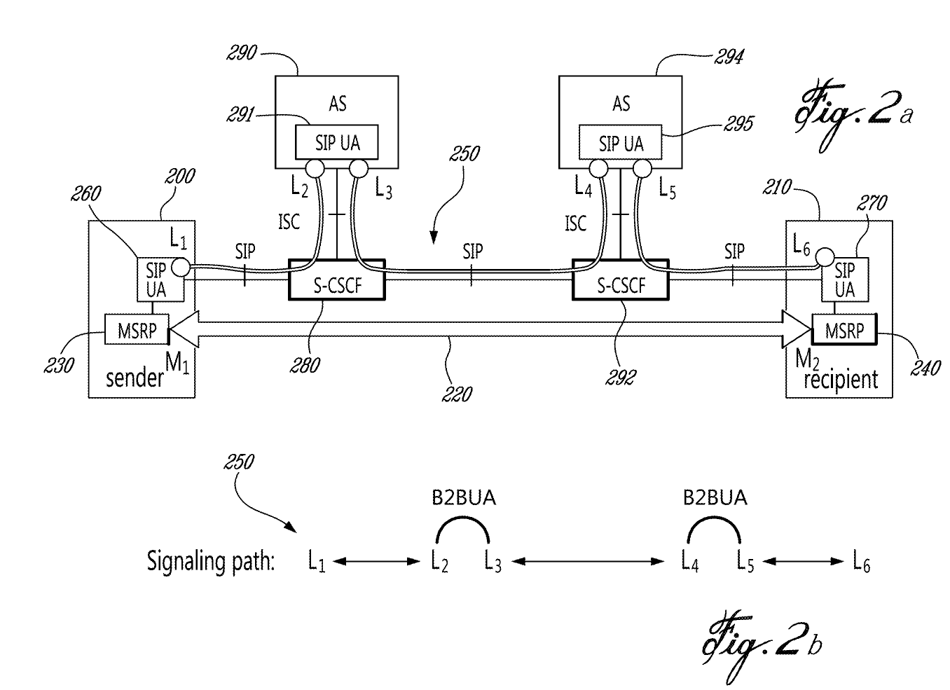

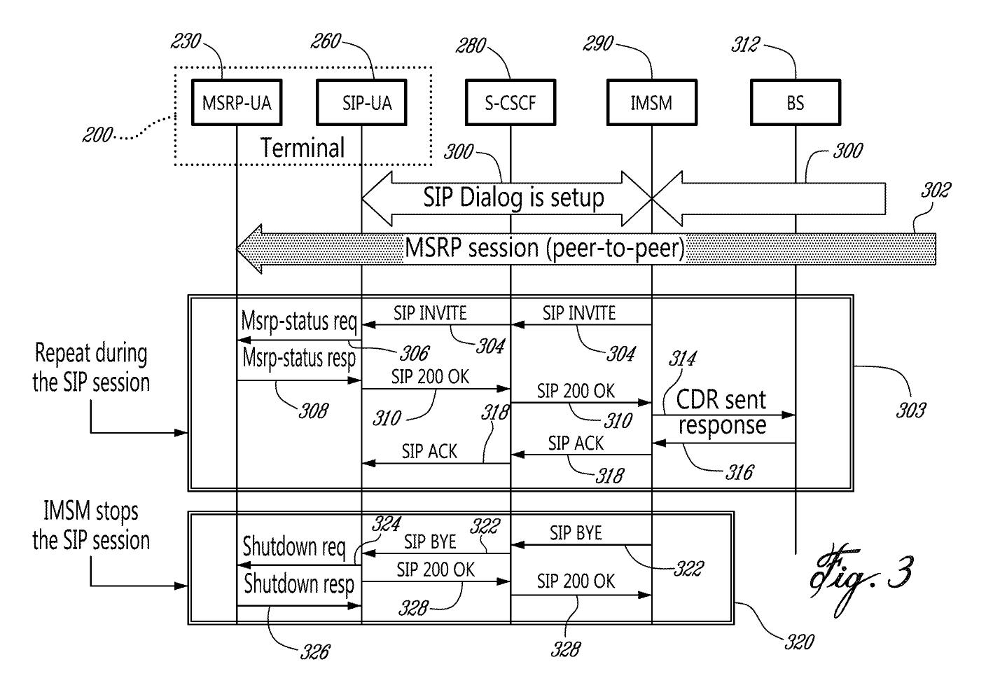

Although these exemplary embodiments refer to communication systems architected in accordance with 3GPP, it will be appreciated that the present invention is not limited thereto. However taking 3GPP communication systems as an example, such systems also typically provide a charging management framework which enables operators to charge customers for the usage of their networks' services. This aspect of charging or billing in 3GPP communication systems will be better understood by considering the example shown in FIG. 2(a).

Therein, a sending mobile unit 200 and a recipient mobile unit 210 are engaged in a direct, peer-to-peer connection to, e.g., transfer multimedia content there between via a media path 220. Although not shown in FIG. 2(a), the media path 220 will typically have various nodes, e.g., radio access points, and other infrastructure nodes for transferring data, associated therewith, which transfer media data between two Message Session Relay Protocol (MSRP) functions 230 and 240, operating within the two mobile units 200 and 210, respectively. As will be apparent to those skilled in the art, MSRP functions 230 and 240 operate to transmit and receive, for example, a series of related instant messages in the context of a session (in this example a SIP session). However, it will be appreciated by those skilled in the art that MSRP functions or sessions as described in these exemplary embodiments are purely illustrative and that other protocols can be used to operate such multimedia functions or sessions. The SIP session set-up and tear down for this peer-to-peer connection is established via the signaling (or control) path denoted generally by the reference numeral 250 and also shown separately in FIG. 2(b). At either end of the signaling path 250, each mobile unit 200 and 210 has a respective SIP User Agent 260 and 270. The SIP User Agents (SIP UAs) 260 and 270 are functions which initiate outgoing SIP requests and which process (and respond to) incoming SIP requests.

To set-up a SIP session for instant messaging (IM) between mobile units 200 and 210, SIP User Agent 260 can send, for example, a SIP INVITE message toward mobile unit 210. As seen in FIG. 2, this SIP INVITE message follows the signaling path 250 to S-CSCF 280, which is the S-CSCF node for mobile unit 200's home network. S-CSCF 280 forwards the SIP INVITE message to the IMS messaging application server 290, which provides instant messaging services for the originating user, via the IMS Service Control (ISC) reference point. The application server 290 (via its respective SIP UA 291) forwards the SIP INVITE message on to the S-SCSF node 292 associated with the recipient's home network which, in turn, conveys the message to the corresponding application server 294 that provides IM services to mobile unit 210. The IMSM AS 294 forwards the SIP INVITE message back through S-CSCF node 292 and on to the recipient's SIP User Agent 270 for processing and acknowledgement, which signaling is also returned via signaling path 250.

In the signaling illustrated in FIG. 2(a), the IMS messaging application servers 290 and 294 (and their respective SIP UAs 291 and 295) are only involved in the signaling path 250, rather than the media path 220. In the signaling path 250, these servers 290 and 294 operate as back-to-back user agents (B2BUA) as shown in FIG. 2(b) for coordinating control signaling over the various control signal path links, which links can be referred to using the endpoints L1-L6 shown in FIG. 2(b). In this role, either or both of the servers 290 and 294 perform, among other functions, the collection of billing information for charging the users of mobile units 200 and 210 for the multimedia connection. However, as mentioned above, this enables the charging to be performed only based on the initial session set-up signaling described above, i.e., it is session-based charging.

According to exemplary embodiments of the present invention, accurate and flexible charging mechanisms are provided by enabling an application server, e.g., the application server 290 and/or 294, to query the MSRP status of the client side during a SIP session. Based on the client's response, the application server which issued the query can determine whether to permit the MSRP or SIP session to continue or, alternatively, whether to tear down that session. Additionally, the client's response can be used by the application server to generate and transmit charging information messages associated with the multimedia connection for billing purposes. Since these exemplary embodiments provide for a pull mechanism, i.e., wherein the network is requesting the information and controls the process, network operators will be able to tailor the process to suit their implementation needs associated with the billing and charging for peer-to-peer multimedia connections.

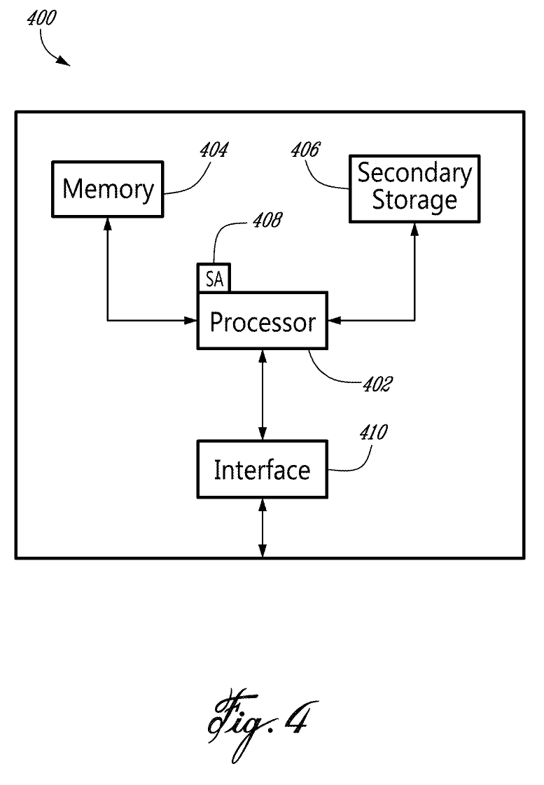

An exemplary signaling technique according to an embodiment is illustrated in FIG. 3. Therein, a SIP dialog or session associated with a peer-to-peer multimedia connection is set-up, as discussed above using, for example, a SIP INVITE, 200 OK and ACK sequence of SIP messages, which signaling is represented by arrows 300. It will be noted that, for clarity of the Figure, only the end of the signaling path associated with one of the terminals 200 is illustrated in this Figure. Once the SIP session is established, the sender 200 starts to send data toward the recipient 210 via its MSRP function 230, as represented by arrow 302. During the SIP and MSRP sessions, e.g., at a predetermined time interval configured by the network operator, the application server 290 can initiate the signaling procedure 303 to query the sender 200's MSRP status associated with the portion of the signaling path L₁-L₂ shown in FIGS. 2(a) and 2(b).

Initially, according to this exemplary embodiment, the application server 290 builds a SIP INVITE (or perhaps more accurately referred to as a re-INVITE since it is within an ongoing session) message 304 using Session Description Protocol (SDP), which message 304 includes one or more media lines (i.e., “m=(some media name and transport address)” indicating that the request is directed to the MSRP 230 and one or more attribute lines (i.e., “a=(some session attribute)” to form the query. As a purely illustrative example, the portion of the SDP in the SIP re-INVITE message 304 associated with this query could be represented as:
m=message 7654 TCP/MSRP*
a=CDR_request.file_name:data_size_sent:data_size_remain

The application server 290 sends this SIP re-INVITE message 304 toward the S-CSCF 280 along the incoming leg L₁-L₂ of the signaling path 250 inside the existing SIP session. S-CSCF 280 passes the receive SIP re-INVITE message 304 to the SIP UA 260 in the terminal 200. The SIP UA 260 interacts with the MSRP function 230 to obtain the information requested by the application server 290. For example, SIP UA 260 can parse the “a= . . . ” line from the SDP carried by the SIP re-INVITE message 304 and use that information to form an internal query, i.e., MSRP-status request message 306, which is sent to MSRP function 230. This MSRP-status request message can include, for example, requests for information about the type of data, e.g., audio, video or other, which has been sent by MSRP function 230 for MSRP session 302 and/or about the type of data to be sent using MSRP session 302.

In response to the request message 306, MSRP 230 will send an MSRP-status response message 308 to SIP UA 260 which includes the requested information. SIP UA 260, in turn, sends updated MSRP status information associated with session 302 to S-CSCF 280, e.g., via a SIP 200 OK message 310. Like the SIP re-INVITE message 304, SIP 200 OK message 310 can carry SDP information associated with the MSRP session status including, e.g., information about the type of data sent, the amount of data sent, the type of data to be sent and the amount of data to be sent. A purely illustrative example of this portion of a SIP 200 OK message, e.g., using SDP media lines “m=(some media name and transport address)” indicating that the request is directed to the application server 290 and one or more SDP attribute lines (i.e., “a=(some session attribute)”, according to an exemplary embodiment is as follows:
m=message 4321 TCP/MSRP*
a=CDR_response:filename:“cool.jpg”:data_size_sent:“250 KB”:data_size_remain: “0 KB”
a=CDR_response:filename:“list.txt”:data_size_sent:.“13 KB”:data_size_remain: “0 KB”
a=CDR_response:filename:“face.avi”:data_size_sent:“2500 KB”:data_size_remain:“1000 KB”

S-CSCF 260 forwards the SIP 200 OK message 310 on to the application server 290 which initiated the query. The application server 290 may, optionally, extract the MSRP status information from the incoming SIP 200 OK message 310 and send that information, e.g., as a Call Detail Record (CDR) message 314, toward a billing system (BS) 312, which will typically acknowledge receipt of that information via response 316. Regardless of whether the application server 290 sends a CDR message 314 as part of its query procedure 303 or not, it will nonetheless acknowledge receipt of the MSRP status information back to the terminal 200 via SIP ACK message 318 via S-CSCF 280.

As mentioned above, the application server 290 which initiated a query regarding the MSRP status of terminal 200 may, based on the status information which was returned or in the absence of a response, decide to tear down the multimedia connection. This can, for example be accomplished by way of the signaling procedure 320 shown in FIG. 3 if the MSRP session to be torn down is the last one to be completed in the corresponding SIP session. Therein, application server 290 sends a SIP BYE message 322, e.g., including an SDP “m= . . . ” line which identifies the MSRP session to be torn down. The SIP BYE message is received by the S-CSCF 280 and forwarded on to the SIP UA 260. SIP UA 260, in turns, processes the SIP BYE message, determines that an MSRP session shutdown command has been received and sends a shutdown request message 324 to MSRP function 230. MSRP function 230 terminates the identified MSRP session and sends a response message 326 to the SIP UA 260. SIP UA 260 reports the shutdown of the MSRP session back to the requesting application server 290 (via S-CSCF 280) using a SIP 200 OK message 328.

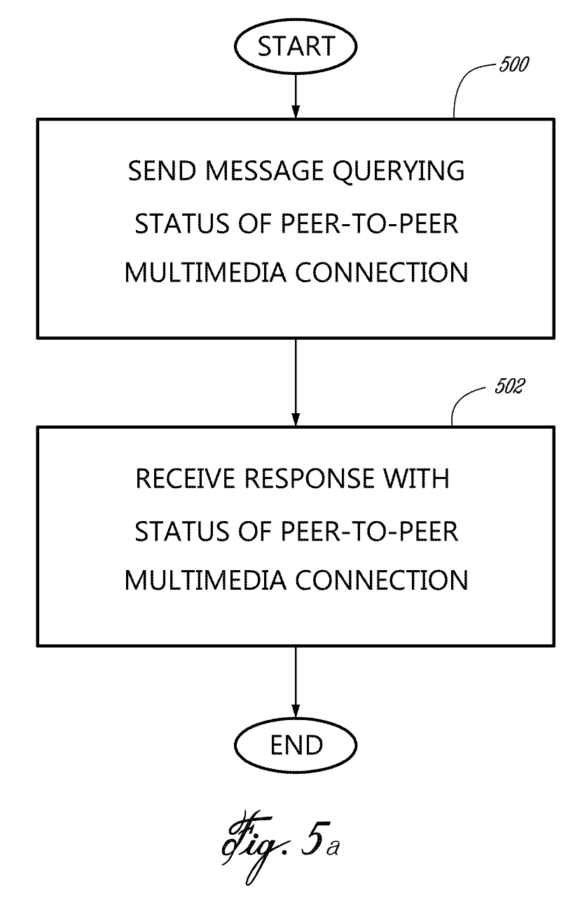

The exemplary embodiments described above illustrate various techniques and systems for querying the status of a peer-to-peer multimedia connection. As stated therein, this involves signaling between terminal devices and communication nodes within a network, e.g., application servers and S-CSCFs. An exemplary communications node or terminal device 400, which is capable of performing the transmission, receipt and processing of the various messages described above is illustrated in FIG. 4. Therein, terminal device or communication node 400 can contain one or more of: a processor 402 (or multiple processor cores), memory 404, one or more secondary storage devices 406, a software application (or multiple applications) 408 and an interface unit 410 to, e.g., facilitate communications between terminal device or communication node 400 and the rest of the network or representative of a wireless transceiver in the case of a mobile terminal. For example, when the structure 400 illustrated in FIG. 4 is operating as a communication node within a network, the processor 402, e.g., in conjunction with the software application 408 which can include a SIP UA 291 or 295, sends a message which queries a status of a peer-to-peer multimedia connection, and which receives a response regarding the status of that peer-to-peer multimedia connection. The memory 404 or secondary storage devices 406 can be used for storage of exemplary items described above, such as status information received in response to a status inquiry. Alternatively, when the structure 400 of FIG. 4 is operating as a terminal device, the processor 402, e.g., in conjunction with the software application 408 which can include a SIP UA 260 and/or an MSRP function 230, receives a message querying a status of a peer-to-peer multimedia connection and sends a response regarding the status of the peer-to-peer multimedia connection.

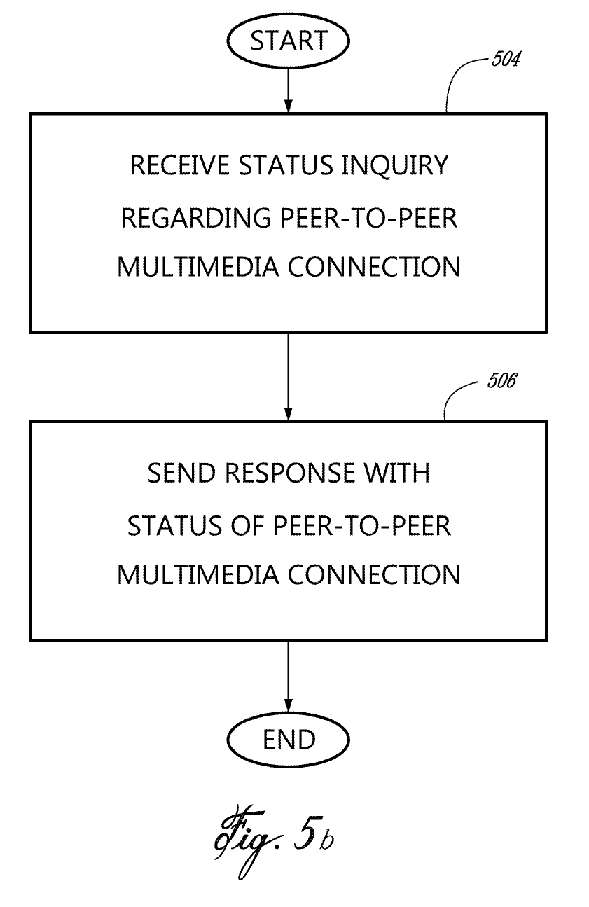

Utilizing the above-described exemplary techniques and systems according to exemplary embodiments, an exemplary method for querying a status of a peer-to-peer multimedia connection, e.g., from the network's perspective, is shown in FIG. 5(a). Therein, at step 500, a message is sent from an application server which queries the status of a peer-to-peer multimedia connection. Then, at step 502, a response is received at an application server regarding the status of the peer-to-peer multimedia connection. Similarly, from a terminal's perspective, a method for handling a status inquiry associated with a peer-to-peer multimedia connection is shown in FIG. 5(b). Therein, at step 504, a message is received at a terminal device which queries the status of a peer-to-peer multimedia connection. Then, at step 506, a response is sent from the terminal device regarding the status of the peer-to-peer multimedia connection.

The above-described exemplary embodiments are intended to be illustrative in all respects, rather than restrictive, of the present invention. Thus the present invention is capable of many variations in detailed implementation that can be derived from the description contained herein by a person skilled in the art. For example, although the foregoing example is performed over the L₁-L₂ leg of the signaling path, the status inquiry could also, for example, be performed over the L₅-L₆ leg of the signaling path. All such variations and modifications are considered to be within the scope and spirit of the present invention as defined by the following claims. No element, act, or instruction used in the description of the present class should be construed as critical or essential to the invention unless explicitly described as such. Also, as used herein, the article “a” is intended to include one or more items.

What is claimed is:

1. A method for querying a status of a peer-to-peer multimedia connection comprising:
sending a message, from an application server, querying said status of said peer-to-peer multimedia connection; and
receiving a response, at said application server, regarding said status of said peer-to-peer multimedia connection.

2. The method of claim 1, wherein said status of said peer-to-peer connection relates to a type of data which has been sent over said peer-to-peer connection.

3. The method of claim 1, wherein said status of said peer-to-peer connection relates to an amount of data which has been sent over said peer-to-peer connection.

4. The method of claim 1, wherein said status of said peer-to-peer connection relates to a type of data which is yet to be sent over said peer-to-peer connection.

5. The method of claim 1, wherein said status of said peer-to-peer connection relates to an amount of data which is yet to be sent over said peer-to-peer connection.

6. The method of claim 1, wherein said message is a Session Initiation Protocol (SIP) INVITE message which carries a Session Description Protocol (SDP) element that identifies a multimedia session for which said status is being queried.

7. The method of claim 1, wherein said response is a Session Initiation Protocol (SIP) 200 OK message which carries a Session Description Protocol (SDP) element that includes status information associated with a multimedia session for which said status is being queried.

8. The method of claim 1, wherein said peer-to-peer connection includes a signaling path, which includes said application server, and a media path, which includes two end user devices but does not include said application server.

9. The method of claim 1, further comprising:
tearing down, by said application server, said peer-to-peer multimedia connection based on said response.

10. The method of claim 1, further comprising:
sending, by said application server, a message including charging information associated with said status toward a billing system.

11. A communication node comprising:
a processor which sends a message which queries a status of a peer-to-peer multimedia connection, and which receives a response regarding said status of said peer-to-peer multimedia connection.

12. The communication node of claim 11, wherein said status of said peer-to-peer connection relates to a type of data which has been sent over said peer-to-peer connection.

13. The communication node of claim 11, wherein said status of said peer-to-peer connection relates to an amount of data which has been sent over said peer-to-peer connection.

14. The communication node of claim 11, wherein said status of said peer-to-peer connection relates to a type of data which is yet to be sent over said peer-to-peer connection.

15. The communication node of claim 11, wherein said status of said peer-to-peer connection relates to an amount of data which is yet to be sent over said peer-to-peer connection.

16. The communication node of claim 11, wherein said message is a Session Initiation Protocol (SIP) INVITE message which carries a Session Description Protocol (SDP) element that identifies a multimedia session for which said status is being queried.

17. The communication node of claim 11, wherein said response is a Session Initiation Protocol (SIP) 200 OK message which carries a Session Description Protocol (SDP) element that includes status information associated with a multimedia session for which said status is being queried.

18. The communication node of claim 11, wherein said peer-to-peer connection includes a signaling path, which includes said communication node, and a media path, which includes two end user devices but does not include said communication node.

19. The communication node of claim 11, wherein said processor selectively tears down said peer-to-peer multimedia connection based on said response.

20. A method for handling a status inquiry associated with a peer-to-peer multimedia connection comprising:
receiving a message, at a terminal device, querying said status of said peer-to-peer multimedia connection; and
sending a response, from said terminal device, regarding said status of said peer-to-peer multimedia connection.

21. The method of claim 20, wherein said status of said peer-to-peer connection relates to a type of data which has been sent over said peer-to-peer connection.

22. The method of claim 20, wherein said status of said peer-to-peer connection relates to an amount of data which has been sent over said peer-to-peer connection.

23. The method of claim 20, wherein said status of said peer-to-peer connection relates to a type of data which is yet to be sent over said peer-to-peer connection.

24. The method of claim 20, wherein said status of said peer-to-peer connection relates to an amount of data which is yet to be sent over said peer-to-peer connection.

25. The method of claim 20, wherein said message is a Session Initiation Protocol (SIP) INVITE message which carries a Session Description Protocol (SDP) element that identifies a Message Session Relay Protocol (MSRP) session for which said status is being queried.

26. The method of claim 20, wherein said response is a Session Initiation Protocol (SIP) 200 OK message which carries a Session Description Protocol (SDP) element that includes status information associated with a multimedia session for which said status is being queried.

27. The method of claim 20, wherein said peer-to-peer connection includes a signaling path, which includes an application server, and a media path, which includes said terminal device and another terminal device but does not include said application server.

28. The method of claim 1, further comprising:
receiving said message at a Session Initiation Protocol User Agent (SIP UA) operating within said terminal device; and
interacting with a multimedia function to obtain said status of said peer-to-peer multimedia connection.

29. A terminal device comprising:
a processor which receives a message querying a status of a peer-to-peer multimedia connection and which sends a response regarding said status of said peer-to-peer multimedia connection.

30. The terminal device of claim 29, wherein said status of said peer-to-peer connection relates to a type of data which has been sent over said peer-to-peer connection.

31. The terminal device of claim 29, wherein said status of said peer-to-peer connection relates to an amount of data which has been sent over said peer-to-peer connection.

32. The terminal device of claim 29, wherein said status of said peer-to-peer connection relates to a type of data which is yet to be sent over said peer-to-peer connection.

33. The terminal device of claim 29, wherein said status of said peer-to-peer connection relates to an amount of data which is yet to be sent over said peer-to-peer connection.

34. The terminal device of claim 29, wherein said message is a Session Initiation Protocol (SIP) INVITE message which carries a Session Description Protocol (SDP) element that identifies a multimedia session for which said status is being queried. See the comments for MSRP.

35. The terminal device of claim 29, wherein said response is a Session Initiation Protocol (SIP) 200 OK message which carries a Session Description Protocol (SDP) element that includes status information associated with a multimedia session for which said status is being queried.

36. The terminal device of claim 29, wherein said peer-to-peer connection includes a signaling path, which includes an application server, and a media path, which includes said terminal device and another terminal device but does not include said application server.

37. The terminal device of claim 29, further comprising:
a Session Initiation Protocol User Agent (SIP UA) operating within said terminal device and which receives said message; and
a multimedia function for handling said peer-to-peer multimedia connection and interacting with said SIP UA to provide status information for said response.
